(19) United States
(12) Patent Application Publication
(10) Pub. No.: US 2025/0326379 A1
(43) Pub. Date: Oct. 23, 2025

(54) Pedal Unit for Controlling a Vehicle Function

(71) Applicant: Robert Bosch GmbH, Stuttgart (DE)

(72) Inventors: Guenter Escher, Oberstdorf (DE); Eduard Maiterth, Heilbronn (DE); Manfred Fischer, Oppenweiler (DE); Simon Baumann, Heilbronn (DE); Stefan Weller, Rauenberg (DE); Tillmann Schatz, Lauffen (DE); Timo Knecht, Mundelsheim (DE)

(21) Appl. No.: 19/177,543

(22) Filed: Apr. 12, 2025

(30) Foreign Application Priority Data
Apr. 18, 2024 (DE) 10 2024 203 609.9

(51) Int. Cl. B60T 7/04; B60K 26/02

(52) U.S. Cl. CPC B60T 7/042; B60K 26/02

(57) ABSTRACT

A pedal unit for controlling a vehicle function includes a pedal head, which receives an actuating force of a driver's foot, an outer housing which is open in the direction of the pedal head, an inner housing connected to the outer housing and which is open in the direction of the pedal head, a movable housing, and a sensor assembly. The movable housing is closed in the direction of the pedal head, arranged between the outer housing and the inner housing, mounted on the inner housing displaceably in the longitudinal extension of the inner housing with a small stroke against the force of a return spring, and is connected to the pedal head. The sensor assembly includes at least one measuring circuit having at least one sensor module arranged inside a sensor housing to detect a stroke movement of the movable housing caused by the actuating force.

This application claims priority under 35 U.S.C. § 119 to application no. DE 10 2024 203 609.9, filed on Apr. 18, 2024 in Germany, the disclosure of which is incorporated herein by reference in its entirety.

The disclosure relates to a pedal unit for controlling a vehicle function.

### BACKGROUND

Drive-by-wire systems with pedal assemblies which transmit driver commands only electrically or electronically are known from the prior art. Such drive-by-wire systems comprise, for example, a pedal assembly with a so-called electronic gas pedal or accelerator pedal for drive control or for executing an acceleration function, as well as a brake pedal for a brake-by-wire system for executing a braking function. Another known drive-by-wire system is a steer-by-wire system for steering control. Drive-by-wire refers to driving or controlling a vehicle without mechanical transmission of power from control elements, such as the accelerator pedal, brake pedal or steering wheel, to the corresponding actuating elements of the vehicle, such as the throttle, brakes and/or steering of the vehicle. In other words, in such drive-by-wire systems, the corresponding pedal unit is decoupled from the power flow, and the aforementioned functions are instead controlled via electrical lines and servo motors or electromechanical actuators. Sensor devices of the drive-by-wire systems conventionally detect a driver specification using force-based sensor units to determine the desired intensity of braking or acceleration of the vehicle and to adjust it accordingly via the powertrain and brake system. Eliminating the mechanical connection makes it possible to implement new pedal concepts, because there is no longer a need for a large pedal travel to achieve vehicle deceleration or vehicle acceleration.

DE 103 12 547 A1 discloses a device for accelerating or decelerating a motor vehicle comprising two actuating elements. A first actuating element is used for accelerating, and a second actuating element is used for decelerating the motor vehicle. The actuating elements are actuated by applying a hand or foot force. The operation of the two actuating elements is largely without travel, and the speed of the motor vehicle is kept constant after the hand or foot force is removed from the first actuating element or from the second actuating element as a function of the most recently applied hand or foot force until the first actuating element or the second actuating element are actuated again.

From the subsequently published DE 10 2023 204 205 A1of the Applicant, a pedal assembly with two pedal units, a pedal unit for controlling a vehicle function, as well as a method for assembling such a pedal unit and a method for disassembling a pedal head from such a pedal unit are known. The pedal unit comprises a modularly constructed pedal head which comprises a pad support and a replaceable pedal pad for receiving an actuating force of a driver's foot and which is connected to a housing cover that is movable via a small stroke along a vertical direction of the pedal unit. The pedal pad is releasably connected to the pad support. In this case, a fastening arrangement is configured to connect the pad support to the movable housing cover in a releasable and form-fit and/or friction-fit manner. The pedal assembly comprises a first pedal unit configured as a brake pedal and a second pedal unit configured as an accelerator pedal.

From the subsequently published DE 10 2024 201 376 A1 of the Applicant, a sensor module for an actuating device of a motor vehicle as well as such an actuating device for a motor vehicle are known. The sensor module comprises a plate-shaped sensor element attributable or associated with an actuating element of the actuating device, and a sensor housing comprising at least a first cylindrical housing part in which the sensor element is longitudinally supported. In addition, the sensor module comprises at least one force sensor element associated with the sensor element for detecting a force exerted on the sensor element by means of the actuating element, and/or at least one displacement sensor element associated with the sensor element for detecting a displacement of the sensor element.

### SUMMARY

The pedal unit for controlling a vehicle function disclosed herein has the advantage that an outer housing, which can be rigidly connected to the vehicle, allows a carpet in the vehicle to be closely adapted to the outer housing without negatively affecting the mobility of a housing within the outer housing that is movable with a small stroke. Due to the small stroke of the movable housing, small displacements typically in the range of fewer millimeters can be achieved. Although the small strokes are only in the range of a few millimeters, the movable housing may sometimes be unfavorable if the pedal unit is to be integrated into a vehicle with a carpet. This disadvantage can be overcome by the outer housing. In addition, sealing measures can also be carried out between the carpet and the pedal unit, even if the carpet has only a low elasticity.

Embodiments of the present disclosure provide a pedal unit for controlling a vehicle function, having a pedal head, which receives an actuating force of a driver's foot, a fixable outer housing which is open in the direction of the pedal head, a fixable inner housing, which is connected to the outer housing and is open in the direction of the pedal head, a movable housing which is closed in the direction of the pedal head, which is arranged between the outer housing and the inner housing and is mounted on the inner housing so as to be displaced in the longitudinal extension of the inner housing with a small stroke against the force of a return spring and is connected to the pedal head, and a sensor assembly, which comprises at least one measuring circuit with at least one sensor module arranged inside a sensor housing which is open in the direction of the pedal head and is arranged inside the inner housing and designed to detect a stroke movement of the movable housing caused by the actuating force of the driver's foot.

In pedal units with a low actuation stroke, the pedal head in conjunction with the movable housing has only a small stroke along the vertical direction of the pedal unit. One advantage of the pedal units with a small stroke and a fixable outer housing is the possibility of positioning the respective pedal unit up to the movable pedal head and the connection area with the movable housing in a vehicle interior panel or under a carpet, such that only the pedal head is visible. The carpet may then be positioned on a carrier plate or on a manufacturer's support. This means that a cut-out of the carpet is limited only to the size of the connection area between the pedal head and the movable housing. If the carpet also had to take into account the larger contour of the pedal head, the cut-out would have to be larger, which would have a negative impact on the overall look. With retrofittable pedal heads, the cut-outs in the carpet reduce to the minimum necessary dimension and are almost completely covered by the pedal heads mounted thereafter.

The outer housing, the inner housing and the movable housing may preferably be configured as thin-walled housing shells made of plastic or metal. The individual housings can in particular be configured as deep-drawn steel sheets, turned, drawn or extruded aluminum profiles, or as injection molded plastic parts and can have a customized coloring. The external shapes of the individual housings may be advantageously adapted to customer interface requirements. The movable housing moves between the inner housing and the outer housing. The return spring generates the counterforce required for the haptic feel when actuated.

In the present case, the at least one sensor module can be understood to mean an electric circuit or component unit with at least one sensor element, which is positioned to measure the stroke of the movable housing caused by the actuation force of the driver foot or the actuation force of the driver's foot. In this case, the at least one sensor module may preferably be configured to detect the small stroke of the movable housing in a contactless manner. For this purpose, there are several possible measurement principles that can be used to measure the stroke of the movable housing. For example, optical, magnetic, inductive or capacitive measuring methods know from the prior art can also be used to detect the small stroke of the movable housing. The actuation force of the driver's foot may be detected, for example, by means of force sensor elements, for example strain gages.

The at least one measuring circuit may comprise a printed circuit board as a circuit carrier on which the at least one sensor module may be arranged. The at least one measuring circuit may comprise an external electrical interface via which measuring signals may be output to a higher-level controller and the at least one measuring circuit may be powered. Analysis logic circuitry in the at least one sensor module may be employed for further analyses, for example data comparison, plausibility check, or the like. Additionally or alternatively, the evaluation can be performed in one or more redundant external evaluation and control units. For this purpose, the at least one measuring circuit may pre-process the measurement signals and convert them into a signal usable for subsequent evaluation and control units. Examples of this include analog data output, in the range of, for example, 0.5 to 4.5 Volts, digital data output, for example, as a PWM signal or SENT signal, or the like. For this purpose, the at least one sensor module of the at least one measuring circuit can, e.g., be what is referred to as an ASIC component or a microcontroller, which can include various functions for detecting and evaluating the sensor signals. However, it is also possible for the at least one sensor module to be configured as an integrated circuit or as a discrete component. Software modules which are, e.g., provided on the microcontroller can also be used to evaluate and/or further process the detected signals. Also advantageous is a computer program product comprising program code stored on a machine-readable carrier, e.g., a semi-conductor memory, a hard disk memory, or an optical memory and used in order to perform the evaluation when the program is executed.

It is particularly advantageous that a closed end face of the movable housing can be configured a hat-shaped connection cap on which the pedal head is fixed. Preferably, the pedal head can be releasably attached to the hat-shaped connection cap via the quick fixation. Here, the pedal head can preferably be modular in design and comprise a pad support and a replaceable pedal pad. In this way, the pad support can be placed onto the connection cap of the movable housing and fixed via the quick fixation. The replaceable pedal pad may be connected to the pad support in a releasable and form-fit and/or force-fit manner. The pad support may be connected to the connection cap of the movable housing in a releasable and form-fit and/or force-fit manner. Preferably. the pedal pad may have a support structure for a better grip of the driver's foot. Due to the modular structure, all work on the pedal pad or on the pad support can then be carried out when disassembled without exerting force on the movable housing or the sensor housing with the at least one measuring circuit. A quick assembly of the pad support on the connection cap of the movable housing or a quick disassembly of the pad support can be implemented, for example, in that the pad support can be connected to the connection cap of the movable housing without tools via a latching and/or plug connection. For disassembly, at least one simple auxiliary tool may then be employed to loosen the latching and/or plug connection. This means that the form-fit and/or force-fit connection can preferably be released with at least one simple auxiliary tool.

In an advantageous configuration of the pedal unit, a plate-shaped coupling element can transfer the stroke movement of the movable housing to the at least one sensor module against the force of at least one spring element. The coupling element may be axially guided in the sensor housing and, at least in the unactuated state, may penetrate a first opening in the sensor housing and a second opening in the inner housing. For this purpose, the sensor housing can comprise at least a first cylindrical housing part in which the coupling element is supported longitudinally. The sensor assembly can thereby be manufactured and mounted independent of the pedal head and a mechanical unit of the pedal unit comprising the outer housing, the inner housing and the movable housing. In particular, the sensor assembly can be inserted particularly easily into the mechanical unit as a pre-assembly group, i.e. as a finished unit. To axially guide the coupling element, the first housing part can have at least one groove and/or a web running along its longitudinal extension on its inner side. Preferably, at least two grooves and/or webs distributed around the circumference of the inner side may be provided, which, for example, may be arranged diametrically opposite to one another. Such grooves and/or wens create a geometrically particularly advantageously simple option for guiding the coupling element, so that the coupling element can be configured as a movable slide. For this purpose, the coupling element can be associated with one longitudinal side the respective groove or the web and inserted into the respective groove or placed on the respective web. Preferably, the coupling element may have, on the longitudinal side, a groove with an inner contour corresponding to the respective outer contour of the web. In particular, the coupling element can be guided in or on the groove or the web in a manner that is free of play or subject to play. For example, the at least one spring element may be configured as a coil spring and operatively connect the coupling element to the at least one sensor module. The at least one spring element results in the advantage that an actuation force exerted on the pedal head can be transferred to the at least one sensor module particularly simply and reliably. In addition, the at least one spring element may be configured to push the coupling element from the inside against the connection cap of the movable housing in order to receive the driver request via this. Additionally, the at least one spring element may serve as a further return spring, thus serving as additional redundancy for the return spring in order to be replaced upon failure, for example when broken, and to return the movable housing of the pedal unit to a home position. This may advantageously prevent the coupling element from falling down and an actuation of the pedal unit being sensed even without a driver's request if the return spring is defective.

In a further advantageous configuration of the pedal unit, two sliding elements can be arranged between the inner housing and the movable housing, between which the return spring is arranged and supported. The two sliding elements each axially abut the inner housing and/or the movable housing. The sliding elements may preferably be configured as plastic plain bearings with a low coefficient of friction or as sintered metal bushes. The two sliding members may preferably be designed such that the return spring is guided internally. For this purpose, the two sliding elements can each comprise an axial protrusion as an internal spring guide and a radial protrusion as a spring support. This can minimize the risk of rattling or scratching noises on uneven roadways or during actuation. The two sliding elements can therefore perform an advantageous dual function. On the one hand, the two sliding elements ensure that the inner housing and the movable housing are displaceable in relation to each other with low friction, and on the other hand, the two sliding elements securely fix the return spring in its position.

In a further advantageous configuration of the pedal unit, the at least one measuring circuit can comprise at least two redundant sensor modules, which can apply different measuring principles or the same measuring principle to detect the movement of the coupling element. For example, at least one of the at least two sensor modules may be configured as a force measurement sensor, which detects the movement of the coupling element via a spring element coupled to the coupling element. Additionally or alternatively, at least one of the at least two sensor modules may be configured as a magnetic travel sensor, which detects the movement of the coupling element via a magnet arranged on the coupling element without contact.

In a particularly advantageous embodiment of the pedal unit, the sensor assembly can comprise two separate measuring circuits each with at least one sensor module and each with an external electrical interface, which are sealed in the sensor housing against each other and outwardly against external media. A base may cover and seal an opening of the sensor housing facing away from the pedal head. For example, when using the pedal unit as a brake pedal to perform a braking function, two sensor modules may each be arranged in both measuring circuits. As a result, the pedal unit configured as a brake pedal may preferably comprise a total of four sensor modules. In this case, two sensor modules may apply a first measurement principle, for example a force measurement, to detect the movement of the coupling element, and two further sensor modules may apply a different second measurement principle, for example a path measurement, to detect the movement of the coupling element. Furthermore, it is possible that the two measuring circuits may each comprise two sensor modules with the same measuring principle. Alternatively, the two measuring circuits may each comprise two sensor modules having different measuring principles. When using the pedal unit as an accelerator pedal to perform an acceleration function, one sensor module may be arranged in each of the two measuring circuits. As a result, the pedal unit configured as an accelerator pedal may preferably comprise a total of two sensor modules. The two sensor modules for detecting the movement of the coupling element may use the same measurement principle, for example force measurement or path measurement, or different measurement principles. For example, the sensor module of the first measuring circuit may apply the force measurement and the sensor module of the second measuring circuit may apply the path measurement to detect the movement of the coupling element. The two measuring circuits can be operated via the two external electrical interfaces using corresponding plugs with separate power supplies. The other measuring circuit is thus not affected if one of the measuring circuits fails, for example. In addition, the components of the two measuring circuits can be mounted separately. By designing the sensor housing with suitable partitions and a base that covers the sensor housing downwards, the separation of the two measuring circuits can be implemented simply and cost-efficiently.

In a further advantageous configuration of the pedal unit, the sensor housing may be fluid-tightly connected to the inner housing. The sensor housing with the separate measuring circuits in the inner housing may be fixed in place using mechanical fasteners such as screws, and/or adhesive. Alternatively, hot or cold forming of plastic components of the sensor housing, such as bolts, bars, etc., could be used to fix the sensor housing to the inner housing. Preferably, the mechanical interface between the sensor housing and the inner housing can be sealed, for example using adhesive or silicone.

In a further advantageous configuration of the pedal unit, the outer housing may be connected and sealed to the movable housing at an opening facing the pedal head via an elastic first seal. The first seal may preferably be configured as a circumferential, bellows-like and elastically deformable sealing element.

In a further advantageous configuration of the pedal unit, the outer housing and the inner housing may be fluid-tightly connected to each other at ends facing away from the pedal head. For this purpose, the outer housing and the inner housing may have circumferential ring flanges on the end faces facing away from the pedal head, each with at least two fastening lugs which at least partially overlap. In this case, the outer housing can be fixed to the at least two fastening lugs, for example using rivets, on the inner housing. For example, alternative fastening methods include adhesive bonding, screws or, in the plastic housing shell design, plastic deformation of an area to ensure a form-fit support on the inner housing. To seal the connection between the inner housing and the outer housing, for example, a second seal configured as a sealing ring or sealing compound can be introduced at the overlap area between the ring flanges of the outer housing and the inner housing. The fixation of the outer housing can also serve to generate an axial pre-load to compress the sealing ring or the sealing compound. The fixable outer housing with the first seal between the outer housing and the movable housing and with the second seal between the outer housing and the inner housing and the seal mounting of the sensor housing sealed by the base in the inner housing can form a mechanical unit that is sealed against external media. This allows the internal electrical and/or electronic components of the at least one measuring circuit to be optimally sealed against external media, such as dust and/or external liquids. Once the pedal unit has been installed in the vehicle, an axial force and fixation can additionally be introduced to the outer housing via screw-on eyelets.

In a further advantageous configuration of the pedal unit, at least one anti-rotation device may be configured between the outer housing and the movable housing, which prevents the movable housing from rotating. For this purpose, the at least one anti-rotation device may have a web on an inner side of the outer housing and a recess with raised ends on an outer side of the movable housing, which are supported on opposite sides of the web. This removes the degree of rotational freedom from the movable housing, so that the movable housing can only move axially in the direction of movement of the pedal head. For example, the outer housing may be fixed to a body of the vehicle using rivets and/or bolts to dissipate the torque and provide support.

In a further advantageous configuration of the pedal unit, a circumferential annular protrusion may be pushed onto the outer housing or formed onto the outer housing. For this purpose, for example, an attachment with a hollow base body can be pushed onto the outer housing, which has the circumferential annular protrusion on an end face facing the pedal head. As already described, the advantage of the fixable outer housing is that a carpet can be fixedly laid thereto without relative movement during actuation and without applying any force on the sensor mechanism and measuring technology. In order to lay the carpet as close to the sensor as possible, the molded circumferential annular protrusion or the circumferential annular protrusion of the attachment can be used as a support for the carpet. Modification of these attachments is possible. For example, screw inserts can be used to seal the carpet by clamping, openings for clamps to press on the carpet, grooves for O-rings for carpet support/sealing, defined surfaces on the top side for gluing to the carpet. The circumferential protrusion as a carpet support may be rigid or elastic. It may also be chained into a hole in the carpet to create an optically appealing finish and then pushed over the outer housing during installation in the vehicle.

In an alternative configuration of the pedal unit, a circumferential elastic annular connection can be pushed onto the outer housing, which has a sealing lip on a radial edge abutting the outer housing and a receiving groove on a radial edge facing away from the outer housing. The circumferential elastic annular connection may preferably be configured as a flexible rubber seal to which a carpet can be tightly connected. In this case, the flexible rubber seal can be used to compensate for installation tolerances. After carpet has been laid, the pedal unit can be mounted.

Exemplary embodiments of the disclosure are illustrated in the drawings and explained in more detail in the following description. In the drawings, identical reference numerals refer to components or elements performing identical or similar functions.

### BRIEF DESCRIPTION OF THE DRAWINGS

FIG. 1 shows a schematic perspective view of a section of a driver's footwell in a vehicle having a pedal assembly, which comprises a first exemplary embodiment of a pedal unit according to the disclosure for controlling a vehicle function and a second exemplary embodiment of a pedal unit according to the disclosure for controlling a vehicle function.

FIG. 2 shows a schematic perspective view of the first exemplary embodiment of the pedal unit of FIG. 1.

FIG. 3 shows a schematic sectional view of a detail III of FIG. 2.

FIG. 4 shows a schematic perspective view of the second exemplary embodiment of the pedal unit of FIG. 1.

FIG. 5 shows a schematic perspective sectional view of a mechanical unit and a sensor assembly of the pedal unit of FIGS. 1 and 2 during installation of the sensor assembly.

FIG. 6 shows a schematic perspective sectional view of a detail VI of FIG. 5.

FIG. 7 shows a schematic perspective partial sectional view of the pedal unit of FIGS. 1, 2 and 5 from below.

FIG. 8 shows a schematic perspective view of the pedal unit of FIGS. 1, 2, 5 and 7 with a first exemplary embodiment of an attachment for connecting a carpet.

FIG. 9 shows a schematic perspective view of the pedal unit of FIGS. 1, 2, 5 and 7 with a second exemplary embodiment of an attachment for connecting a carpet.

FIG. 10 shows a schematic perspective view of the pedal unit of FIGS. 1, 2, 5 and 7 with a third exemplary embodiment of an attachment for connecting a carpet.

FIG. 11 shows a schematic perspective view of a section of a vehicle floor with a pedal unit of FIGS. 1, 2, 5 and 7 without a pedal head.

FIG. 12 shows the cut-out of the vehicle floor in FIG. 11 with the pedal unit of FIGS. 1, 2, 5 and 7.

### DETAILED DESCRIPTION

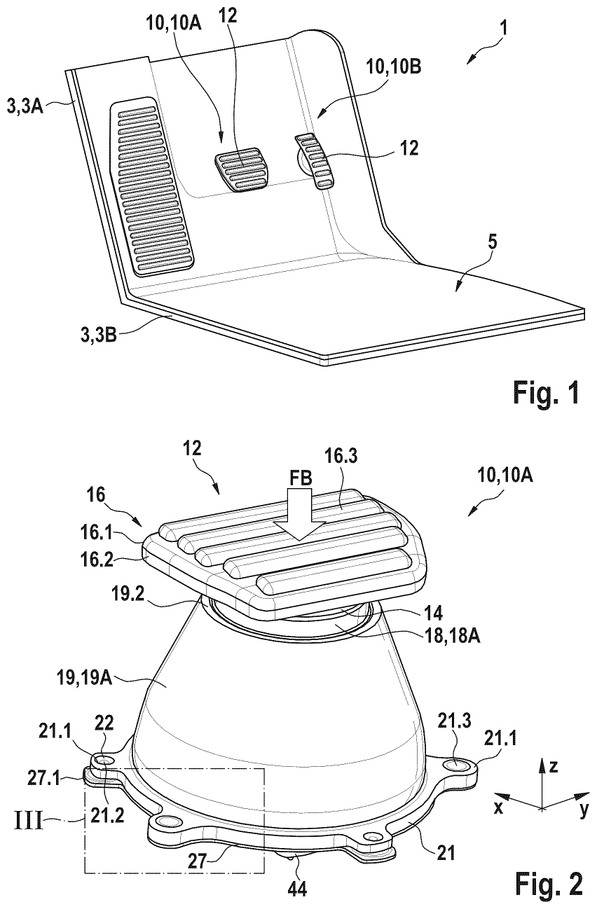

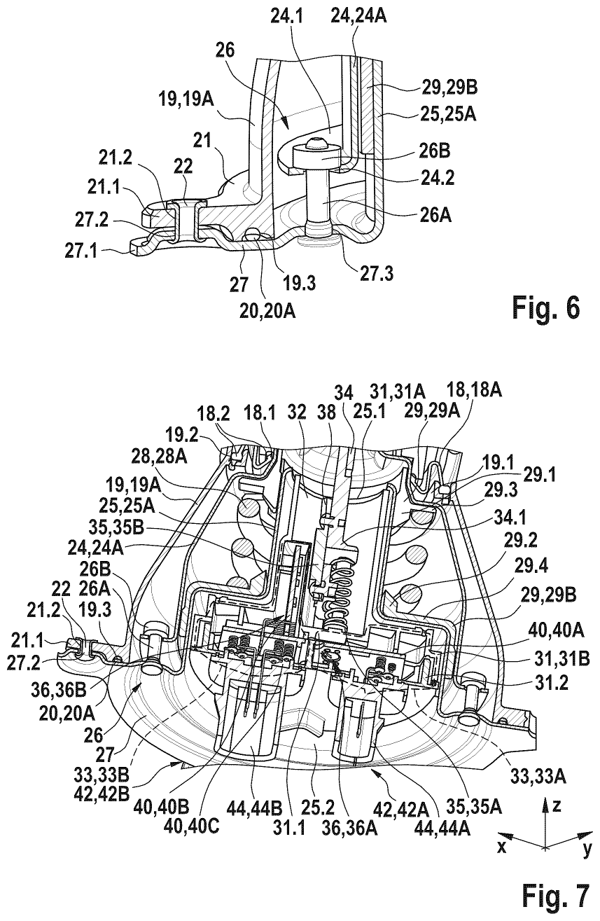

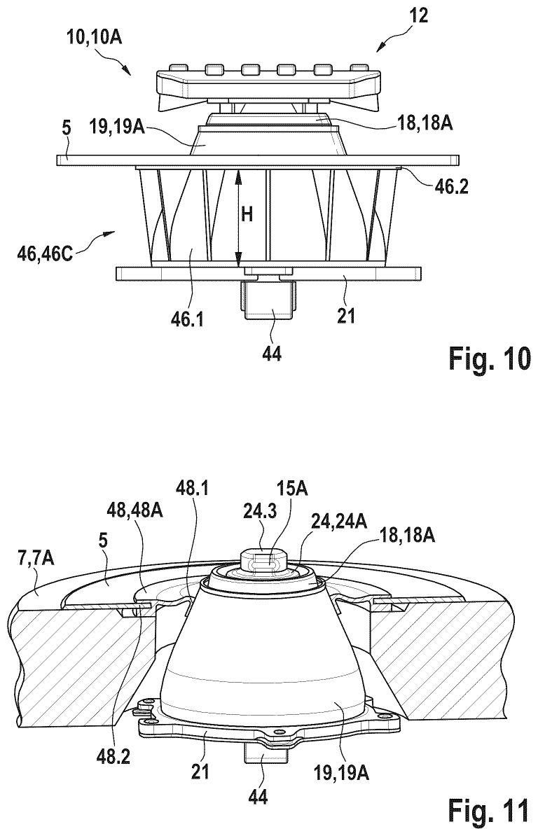

As can be seen from FIGS. 1-12, the illustrated exemplary embodiments of a pedal unit 10 according to the disclosure for controlling a vehicle function each have a pedal head 12, which receives an actuating force FB of a driver's foot, a fixable outer housing 19 which is open in the direction of the pedal head 12, a fixable inner housing 25, which is connected to the outer housing 19 and is open in the direction of the pedal head 12, a movable housing 24 which is closed in the direction of the pedal head 12, which is arranged between the outer housing 19 and the inner housing 25 and is mounted on the inner housing 25 so as to be displaced in the longitudinal extension of the inner housing 25 with a small stroke against the force of a return spring 28 and is connected to the pedal head 10, and a sensor assembly 30, which comprises at least one measuring circuit 33 with at least one sensor module 36 arranged inside a sensor housing 31 open in the direction of the pedal head 12 and is arranged inside the inner housing 25 and designed to detect a stroke movement of the movable housing 24 caused by the actuating force FB of the driver's foot.

As can further be seen from FIG. 1, a pedal assembly 1 is arranged in the depicted section of the driver-side footwell of a vehicle with two exemplary embodiments of the pedal unit 10 according to the disclosure for actuating a vehicle function on a body 3 of the corresponding vehicle. Here, the two pedal units 10 are each arranged on and fixed to a partition 3A between the vehicle interior and an engine compartment. Here, a left pedal unit 10 shown is embodied as a brake pedal 10A for performing a braking function, and a right pedal unit 10 shown is embodied as an accelerator pedal 10B for performing an acceleration function. In both exemplary embodiments of the pedal unit 10, the small stroke of the movable housing 24 is in the range of a few millimeters. In a non-illustrated alternative exemplary embodiment, the two pedal units 10 are arranged on and fixed to a vehicle floor 3B. As can be seen further in FIG. 1, the partition 3A and the vehicle floor 3B are covered with a carpet 5.

In the illustrated exemplary embodiments of the pedal unit 10, the pedal head 12 is modularly designed and comprises a pad support 14 and a replaceable pedal pad 16. In each of the exemplary embodiments shown, the pedal pad 16 of the pedal head 10 comprises a curved stainless steel thermoformed bowl 16.1, which is combined with a curved rubber component 16.2, such that a strip-shaped support structure 16.3 protruding from the thermoformed bowl 16.1 is formed on a top side of the thermoformed bowl 16.1. The support structure 16.3 can prevent or at least make it difficult for the driver's foot to slip. The pedal pad 16 is fixedly mounted on the pad support 14. For this purpose, the rubber component 16.2 comprises a circumferential receiving groove that is not visible, in which a circumferential edge of the pad support 14 that is not visible is inserted, such that a wall of the receiving groove configured as a flexible lip encompasses the edge of the pad support 14.

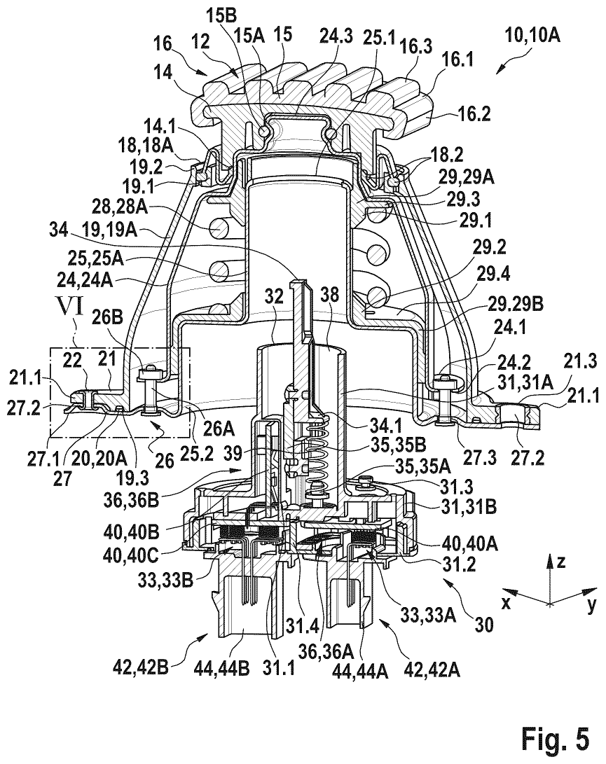

As can further be seen in particular in FIG. 5, a closed end face of the movable housing 24 is configured as a hat-shaped connection cap 24.3 on which the pedal head 12 is fixed. For this purpose, the pad support 14 is attached to the hat-shaped connection cap 24.3 of the movable housing 24 and fixed via a quick fixation 15. The quick fixation 15 in the illustrated exemplary embodiment comprises two fixation grooves 15A configured on the hat-shaped connection cap 24.3, which run perpendicular to the stroke movement of the movable housing 24, and two fixation pins 15B. The pad support 14 has two through-openings that are not visible, which align with the two fixation grooves 15A when attached. The two fixation pins 15B each penetrate through one of the through-openings in the pad support 14 and one of the two fixation grooves 15A in the hat-shaped connection cap 24.3 when mounted. As a result, the pedal head 12 is releasably fixed to the hat-shaped connection cap 24.3.

In the illustrated exemplary embodiments, the outer housing 19 is connected and sealed to the movable housing 24 at an opening 19.1 facing the pedal head 12 via an elastic first seal 18. The first seal 18 in the illustrated exemplary embodiments of the pedal unit 10 is respectively configured as an elastic bellows 18A, which has a sealing lip 18.2 on an outer edge and on an inner edge delimiting a through-opening 18.1. Here, a circumferential sealing groove 19.2 is introduced at an edge of the opening 19.1 in the outer housing 19, which receives the sealing lip 18.2 at the outer edge of the bellows 18A. The sealing lip 18.2 configured at the inner edge of the bellows 18A is received by a further sealing groove 14.1 inserted into the pad support 14.

As can be seen in particular from FIGS. 2 to 7, the outer housing 19 and the inner housing 25 are fluid-tightly connected to each other on the end faces facing away from the pedal head 12. For this purpose, the outer housing 19 and the inner housing 25 have circumferential ring flanges 21, 27 on the end faces facing away from the pedal head 12, each with at least two fastening lugs 21.1, 27.1 which at least partially overlap. In the illustrated exemplary embodiments, the outer housing 19 is fixed to a plurality of fastening lugs 21.1 using fasteners 22 configured as rivets to corresponding fastening lugs 27.1 of the inner housing 25. To install the pedal unit 10 in the vehicle, screw-on openings 21.3, 27.2 are introduced into a plurality of fastening lugs 21.1 of the outer housing 19 and corresponding fastening lugs 27.1 of the inner housing 25. To fasten to the body 3, a fastening element designed as a screw preferably penetrates the screw-on openings 21.3, 27.2, such that the pedal unit 10 is screwed to the body 3 or the partition 3A or to the vehicle floor 3B via the outer housing 19 and the inner housing 25 and is arranged in a fixed position in relation to the body 3. To seal the connection between the inner housing 25 and the outer housing 19, a second seal 20 configured as a sealing ring 20A is introduced at the overlap area between the ring flanges 21, 27.1 of the inner housing and the outer housing. By fixing the outer housing 19 to the inner housing 25, an axial bias is generated that compresses the sealing ring 20A.

As can be seen in particular from FIGS. 5 and 7, the outer housing 19, the movable housing 24 and the inner housing 25 are each configured at least in segments as cylindrical closed housing shells 19A, 24A, 25A. Thus, the movable housing 24 has a thin-walled casing wall, which transitions into the hat-shaped connection cap 24.3 on an end face facing the pedal head 12 and has an opening and a radially circumferential protrusion 24.1 on an end face facing away from the pedal head 12. The outer housing 19 and the inner housing 25 each have a thin-walled casing wall, which is arranged open on both end faces. The outer housing 19, the movable housing 24 and the inner housing 25 each only have a constant cross section in some regions or in sections. The outer housing 19, the movable housing 24 and the inner housing 25 are configured as plastic parts or metal parts, for example, in particular as deep-drawn sheets, turned, drawn, or extruded aluminum profiles, or as injection-molded plastic portions.

As can be further seen from FIGS. 5 and 7, two sliding elements 29 are arranged between the movable housing 24 and the inner housing 25. The two sliding elements 29 each axially abut the movable housing 24 and/or the inner housing 25. In the exemplary embodiments shown, the sliding elements 29 are each configured as plastic sliding bearings with a low friction value. The return spring 28 is configured as a coil spring 28A in the illustrated exemplary embodiments and is biased between the sliding elements 29 and arranged coaxially to the movable housing 24 and the inner housing 25 to push into the movable housing 24 to an unactuated rest position. Here, a first sliding element 29A is displaceable along the longitudinal extension of the inner housing 25 together with the movable housing 24 relative to the inner housing 25. A second sliding element 29B is fixedly arranged on the inner housing 25. The movable housing 24 is correspondingly displaceable along the longitudinal extension of the inner housing 25 relative to the second sliding element 29B.

The movable housing 24 has an outer side and an inner side facing away from the outer side. Similarly, the inner housing 25 has an outer side facing the inner side of the movable housing 24 and an inner side facing away from the outer side. The first sliding element 29A has a first outer surface and a first inner surface facing away from the first outer surface. Similarly, the second sliding element 29B has a second outer surface and a second inner surface facing away from the second surface. The first sliding element 29 A abuts the first outer surface on the inner side of the movable housing 24 and the first inner surface 21 on the outer side of the inner housing 25. The second sliding element 29B in turn abuts the second outer surface on the inner side of the movable housing 24 and the second inner surface on the outer side of the inner housing 25.

As can be seen further from FIGS. 5 and 7, the movable housing 24 in the exemplary embodiments also has a conical portion along its longitudinal extension in addition to cylindrical portions. This means that the movable housing 24 has, along its longitudinal extension, at least one region in which its cross-sectional area or diameter is not constant but varies continuously. It has a first constant inner diameter in a first cylindrical area associated with the first sliding element 29A and a second constant inner diameter, which is greater than the first inner diameter, in a second cylindrical area associated with the second sliding element 29B. This applies analogously to the corresponding outer diameters of the movable housing 24. The first cylindrical area of the movable housing 24 is arranged at the end of the movable housing 24 facing the pedal head 12 as seen in the longitudinal extension. The second cylindrical area of the movable housing 24 is arranged at the end of the movable housing 24 facing away from the pedal head 12. The conical shape is created by the first region and the second region of the movable housing 24 being connected by a third region, in which the first inner diameter and the first outer diameter widen continuously to form the second inner diameter and the second outer diameter. Similarly, the inner housing 25 has, in a first region associated with the first sliding element 29A, a first constant inner diameter and a first constant outer diameter, and, in a second region associated with the second sliding element 29B, a second constant inner diameter and a second constant outer diameter. Here, the second inner diameter and the second outer diameter are each greater than the first inner diameter and the first outer diameter.

As can be seen from FIGS. 5 and 7, the sliding elements 29 are configured to correspond geometrically to the sliding element in that they are each at least essentially cylindrical in shape or each have at least one correspondingly cylindrical portion. At least in this portion, the two sliding elements 29 have an outer diameter corresponding to the respective inner diameter of the movable housing 24 and an inner diameter corresponding to the respective outer diameter of the inner housing 25. Thus, the first sliding element 29A is arranged in a form-fit or force-fit manner and/or material-fit manner in the first cylindrical area of the movable housing 24, in particular, pressed in, so that it does not slide relative to the movable housing 24. The second sliding element 29B is arranged in a form-fit or force-fit and/or material-fit manner at the second cylindrical area of the inner housing 25, in particular pressed in, so that it does not slide relative to the inner housing 25.

The two sliding elements 29 each have a circumferential axial protrusion 29.1, 29.2 as an internal spring guide in the direction of the longitudinal extension of the inner housing 25 and in the direction of the return spring 28. In the present case, the return spring 28 is arranged surrounding the first cylindrical area of the inner housing 25 and is radially fixed by the axial protrusions 29.1, 29.2 of the two sliding elements 29 and has an inner diameter corresponding to the first outer diameter of the inner housing 25 and the thickness of the axial protrusions 29.1, 29.2. In order to also securely fix the return spring 28 axially between the sliding elements 29, in the present case the first sliding element 29A has, in addition to a first circumferential axial protrusion 29.1 at an end associated with the return spring 28, a first circumferential radial protrusion 29.3 which is connected to the first circumferential axial protrusion 29.1. Also, in addition to a second circumferential axial protrusion 29.2, at an end associated with the return spring 28, the second sliding member 29B has a second circumferential radial protrusion 29.4, which connects to the second circumferential axial protrusion 29.2. As can be further seen in FIGS. 5 and 7, the second circumferential radial protrusion 29.4 transitions into a cylindrical area of the second sliding element 29B, which is pressed onto the inner housing 25. A first end of the return spring 28 abuts a surface of the first radial protrusion 29.3 of the first sliding member 29A facing the second sliding member 29B, at least in some areas. Furthermore, a second end of the return spring 28 abuts a surface of the second radial protrusion 29.4 of the second sliding element 29B facing the first sliding element 29A, at least in some areas. Thus, the return spring 28 is axially fixed at both ends.

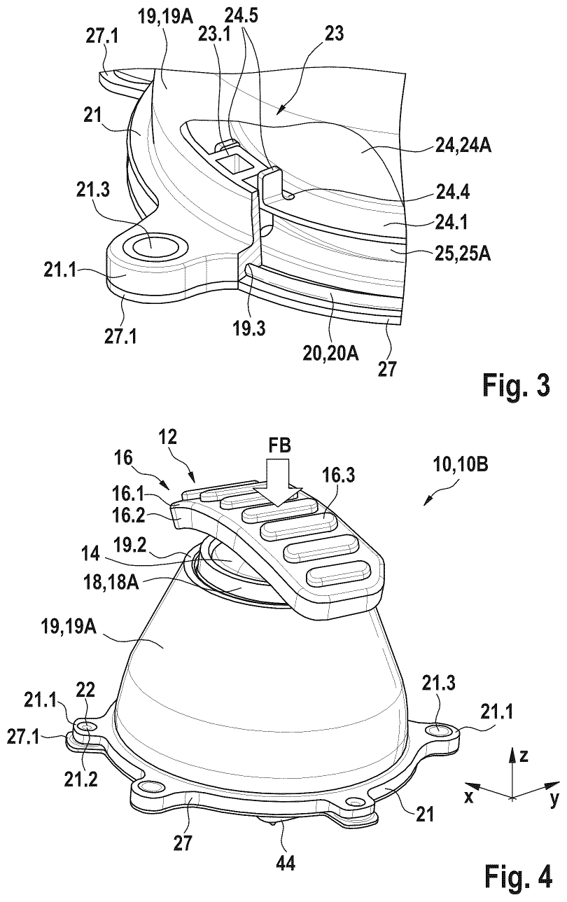

In particular, it can be seen from FIG. 3, at least one anti-rotation device 23 is configured between the outer housing 19 and the movable housing 24, which prevents the movable housing 24 from rotating. In the illustrated exemplary embodiment, the at least one anti-rotation device 23 has a web 23.1 on an inner side of the outer housing 19 and a recess 24.4 with raised ends 24.5 on an outer side of the movable housing 24, which are supported on opposite sides of the web 23.1. In this case, the recess 24.4 with the raised ends 24.5 is inserted into the radially circumferential protrusion 24.1 of the movable housing 24. As a result of the anti-rotation device 23, the degree of rotational freedom from the movable housing 24 is removed, so that the movable housing 24 can only move axially in the direction of movement of the pedal head 12. Preferably, the illustrated exemplary embodiments have anti-rotation devices 23 arranged diametrically opposite each other.

As can be seen in particular in FIGS. 5 to 7, at least one stroke adjustment 26 is configured between the inner housing 25 and the movable housing 24, which allows adjustment of the stroke of the movable housing 24. For this purpose, the at least one stroke adjustment 26 comprises a press-in pin 26A and a press sleeve 26B. In this respect, the press-in pin 26A is pressed into a press-in opening 27.3, which is inserted into the circumferential second ring flange 27.1 of the inner housing 25, and penetrates an opening 24.2, which is inserted into the radially circumferential protrusion 24.1 of the movable housing 24. An axial stop in the form of the press sleeve 26B circumferentially surrounding the press-in pin 26A is arranged on the press-in pin 26A at its end region facing away from the movable housing 24 in order to predetermine the stroke of the movable housing 24 relative to the inner housing 25. The press sleeve 26B and the axial stop, respectively, are mounted when the press-in pin 26A is inserted through the opening 24.2. The stroke of the movable housing 24 can be adjusted via the pressing sleeve 26B pressed onto the press-in pin 26A. In addition, the stroke adjustment 26 also ensures that the inner housing 25 and the movable housing 24 are securely held together. The stroke adjustment 26 also defines a bias of the return spring 28 or the bias is adjusted as a function of the length of the press-in pin 26A, respectively. Alternatively, the press sleeve 26B may also be welded onto the corresponding press-in pins 26A. In the illustrated exemplary embodiment, two stroke settings 26, which are diametrically opposite to one another, are provided.

The components of the pedal unit 10 described so far are purely mechanical or a kind of mechanical unit of the pedal unit 10. However, it can be seen in FIGS. 5 and 7 that the interior of the inner housing 25 forms a stepped cavity into which the sensor housing 31 of the sensor assembly 30 can be inserted and is fluid-tightly connectable to the inner housing 25. The sensor housing 31 can be precisely arranged in the inner housing 25 and comprises two interconnected cylindrical housing parts 31A, 31B with different inner diameters and different outer diameters. Here, the outer diameters of the cylindrical housing parts 31A, 31B of the sensor housing 31 are adapted to the inner diameters of the corresponding cylindrical areas of the inner housing 25. The sensor housing 31 in the inner housing 35 may be fixed in place, for example using mechanical fasteners 31.3, such as screws, and/or adhesive. Preferably, the mechanical interface between the sensor housing 31 and the inner housing 35 can be sealed, for example using adhesive or silicone.

The sensor assembly 30 is designed to detect an actuation of the pedal unit 10, in particular an actuation force FB applied to the pedal head 12 and/or a stroke of the pedal head 12 and the movable housing 24, respectively. In the illustrated exemplary embodiments, the sensor assembly 30 comprises two separate measuring circuits 33 each with at least one sensor module 36 and each with an external electrical interface 42 and a plug 44, which are sealed in the sensor housing 31 against each other and outwardly against external media. Here, a floor 31.2 covers and seals an opening in the sensor housing 31 facing away from the pedal head 12.

As can further be seen in particular in FIGS. 5 and 7, a plate-shaped coupling element 34, which is made of metal or plastic, transfers the stroke movement of the movable housing 24 against the force of at least one spring element 39 to the at least one sensor module 36. The coupling element 34 is axially guided in a first upper housing part 31A of the sensor housing 31, which is at the top in the embodiments, and penetrates a first opening 32 in the sensor housing 31 facing the pedal head 12 and the second opening 25.1 in the inner housing 25 facing the pedal head 12, at least when unactuated, and abuts one end facing the pedal head 12 on an inner side of the hat-shaped connection cap 24.3 of the movable housing 24.

The sensor assembly 30 comprises at least two redundant sensor modules 36 that employ different measurement principles or the same measurement principle to detect the movement of the coupling element 34. At least one of the at least two sensor modules 36 is configured as a force measurement sensor 36A, which detects the movement of the coupling element 34 via a spring element 39 coupled to the coupling element 34. In addition, at least one of the at least two sensor modules 36 is configured as a magnetic travel sensor 36B, which detects the movement of the coupling element 34 via a magnet 35B arranged on the coupling element 34 without contact. The force measurement sensor 36A comprises in particular strain gauges and is in particular configured as described in the previously known prior art of the applicant mentioned at the beginning. For the sensor assembly 30 to function as desired, it is sufficient if either the force measurement sensor 36A or the magnetic travel sensor 36B are present. However, if both different measurement principles are used, this results in an advantageous heterogeneous redundancy. In the illustrated exemplary embodiment of the pedal unit 10 configured as brake pedal 10A for controlling a braking function, two force measurement sensors 36A and two magnetic travel sensor 36B are arranged in the two separate measuring circuits 33. In the illustrated exemplary embodiment of the pedal unit 10 configured as the travel pedal 10A for controlling an acceleration function, two sensor modules 36 are arranged in the two separate measuring circuits 33. Here, two force measurement sensors 36A or two magnetic travel sensors 36B or one force measurement sensor 36A and one magnetic travel sensor 36B may be used.

In this way, such redundancy in particular fulfills corresponding standards and/or laws in order to meet quality/safety requirements. For example, two different measuring principles are prescribed for brake pedals 10A, and these are each redundant in order to be ASIL-D capable. For accelerator pedals 10B, two redundant sensors with the same measuring principle are sufficient.

A guide 38 of the longitudinally supported coupling element 34 arranged on an inner side of the first housing part 31A of the sensor housing 31 comprises a groove and/or a web extending along its longitudinal extension of the first housing part 31A. Preferably, two diametrically opposite guides 38 for the coupling element 34 are arranged on the inner side of the first housing part 31A of the sensor housing 31. The coupling element 34 is associated with one longitudinal side of the respective guide 38, in particular inserted into the respective groove or placed on the respective web. For this purpose, the coupling element 34 has, on the longitudinal side, a groove with an inner contour corresponding to the respective outer contour of the web. Preferably, the coupling element 34 is guided at least approximately in a play-free manner in the guide 38.

In the illustrated exemplary embodiments, the sensor assembly 30 comprises at least one spring element 39 configured as a coil spring. The coupling element 34 is operatively connected via the spring element 39 to the sensor module 36, configured as the force sensor 36A, which is arranged in a first measuring circuit 33A. In an alternative embodiment not shown in which a load measuring sensor 36A is not present, the coupling element 34 is supported via the spring element 39 on the sensor housing 31. A first end of the spring element 39 is pushed onto a protrusion 34.1 of the coupling element 34, at least in some areas, and with a second end facing away from the first end is pushed onto a protrusion of a transmitter element 35 designed as transmission element 35A, at least in areas, which is operatively connected to the sensor module 36 designed as the force measurement sensor 36A.

As can further be seen in FIGS. 5 and 7, a transmitter element 35 designed as a magnet 35B is arranged on the coupling element 34, which interacts with a sensor module 36, designed as a magnetic travel sensor 36B arranged in a second measuring circuit 33B. Here, the magnetic travel sensor 36B may preferably comprise a Hall sensor element. For example, the magnet 35B is arranged on a longitudinal side of the coupling element 34, and in particular is connected to the coupling element 34 in a form-fit, force-fit and/or material fit manner.

As can further be seen in FIGS. 5 and 7, the sensor module 36 designed as the force measurement sensor 36A and the sensor module 36 designed as the magnetic travel sensor 36B, are arranged on different circuit carriers 40, each associated with one of the two measuring circuits 33 and arranged in separate areas of the sensor housing 31 separated from each other by partitions 31.1. For this purpose, a first circuit carrier 40A, on which the sensor module 36 of the first measuring circuit 33A designed as the force sensor 36A, and a part of a first external electrical interface 42A of the first measuring circuit 33A are arranged, is arranged in a portion of a second cylindrical housing part 31B on the right in the illustration. A second circuit carrier 40B on which the sensor module 36 of the second measuring circuit 33B designed as the magnetic travel sensor 36B is arranged, is arranged in a left portion of the first cylindrical housing part 31A of the sensor housing 31 separated by partitions 31.1. A third circuit carrier 40C, on which a part of a second external electrical interface 42B of the second measuring circuit 33B is arranged, is arranged in a left portion of the second housing part 31B of the sensor housing 31 separated by a partition 34.1 formed at the bottom 31.2 of the sensor housing 31. Here, the second circuit carrier 40B is arranged perpendicular to the third circuit carrier 40C. A further part of the first external electrical interface 42A of the first measuring circuit 33A is configured as a first plug 44A and is arranged on the right portion of the bottom 31.2 of the sensor housing 31 in the illustration. A second part of the second external electrical interface 42B of the second measuring circuit 33B is arranged as a second plug 44B and is arranged on the left portion of the bottom 31.2 of the sensor housing 31 in the illustration. In the exemplary embodiments shown, the first circuit carrier 40A and the third circuit carrier 40C are in a common plane, but are mounted separately from each other. Here, on the side of the first circuit carrier 40A facing away from the corresponding sensor module 36, further unspecified spring elements are arranged, which electrically contact the first part of the first external electrical interface 42A with unspecified contact elements of the first plug 44A. On the side of the third circuit carrier 40C facing away from the corresponding sensor module 36, further unspecified spring elements are arranged, which electrically contact the first part of the second external electrical interface 42B with unspecified contact elements of the second plug 44A.

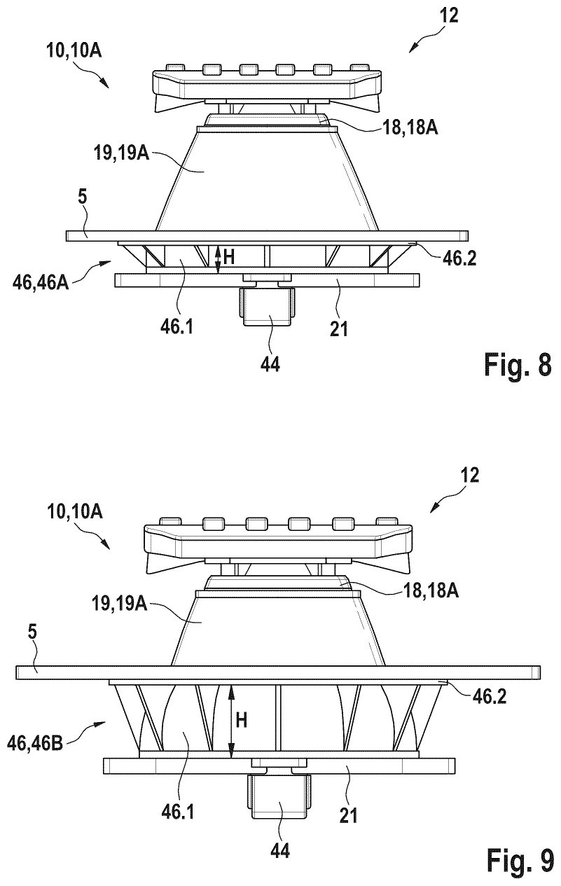

As can further be seen in FIGS. 8 to 10, in the first exemplary embodiment of the pedal unit 10 shown, an attachment 46 with a hollow base body 46.1 is pushed onto the outer housing 19, which has a circumferential annular protrusion 46.2 on an end face facing the pedal head 12, which provides a support surface for the carpet 5. As can be further seen in FIGS. 8 to 10, the exemplary embodiment of the attachment 46A, 46B, 46C have different heights H, so that the pedal unit 10 can be adapted to different installation conditions. As a result, the carpet 5 can be laid fixedly to the outer housing 19 without relative movement upon actuation of the pedal unit 10 and without applying force on the movable housing 24 and the measurement technology. The attachment 46 may be rigid or elastic. In addition, the attachment 46 can also be chained into a hole in the carpet 5 in order to obtain an optically appealing finish. When installed in the vehicle, the attachment 46 with the carpet 5 can then be pushed over the pedal unit 10 without the pedal head 12. Subsequently, the pedal head 12 may be attached and fixed to the connection cap 24.3 of the movable housing 24.

In an alternative embodiment of the pedal unit 10 not shown, the circumferential annular protrusion 46.2 is molded onto the outer housing 19.

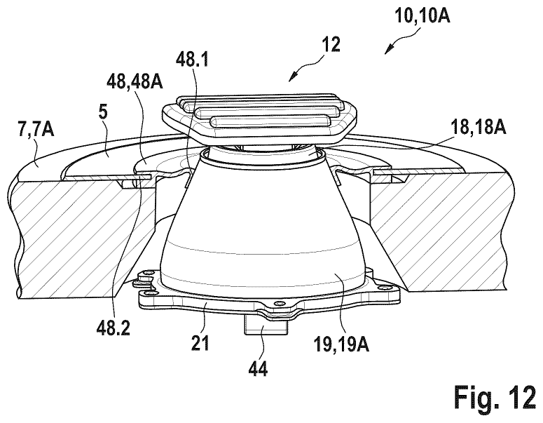

As can further be seen in FIGS. 11 and 12, in the illustrated design example of the pedal unit 10, a circumferential elastic annular connection 48 is pushed onto the outer housing 19, which has a sealing lip 48.1 on a radial edge abutting the outer housing 19 and a receiving groove 48.2 on a radial edge facing away from the outer housing 19. As can further be seen in FIGS. 11 and 12, a substructure 7 is arranged around the pedal unit 10, which is configured as insulating material 7A in the illustrated exemplary embodiment. The insulating material 7A, for example in the form of a foam insert, also supports the carpet 5 around the pedal unit 10. As can further be seen in FIGS. 11 and 12, the carpet 5 is inserted into the receiving groove 48.2 of the annular connection 48 configured as a rubber seal 48A while the sealing lip 48.1 abuts the outer housing 19. As can be further seen in FIG. 11, when installed in the vehicle, the connection 48 configured as a rubber seal 48A with the carpet 5 is pushed over the pedal unit 10 without the pedal head 12. As can be further seen in FIG. 12, the pedal head 12 is subsequently pushed on and fixed to the connection cap 24.3 of movable housing 24.

1. A pedal unit for controlling a vehicle function, comprising:
a pedal head configured to receive an actuating force of a driver's foot;
a fixable outer housing, which is open in a direction of the pedal head;
a fixable inner housing, which is connected to the fixable outer housing and is open in the direction of the pedal head;
a movable housing, which is closed in the direction of the pedal head and which is arranged between the fixable outer housing and the fixable inner housing and is mounted on the fixable inner housing so as to be displaced in a longitudinal extension of the inner housing with a small stroke against a force of a return spring, the movable housing being connected to the pedal head; and
a sensor assembly configured to detect a stroke movement of the movable housing caused by the actuating force of the driver's foot, the sensor assembly comprising:
a sensor housing which is open in the direction of the pedal head and is arranged inside the fixable inner housing; and
at least one measuring circuit with at least one sensor module arranged inside the sensor housing.

2. The pedal unit according to claim 1, wherein the movable housing has a closed end face configured as a hat-shaped connection cap and on which on which the pedal head is fixed.

3. The pedal unit according to claim 1, further comprising a plate-shaped coupling element configured to transfer the stroke movement of the movable housing, against a force of at least one spring element, to the at least one sensor module.

4. The pedal unit according to claim 3, wherein the plate-shaped coupling element is axially guided in the sensor housing and, at least in an unactuated state, penetrates a first opening in the sensor housing and a second opening in the inner housing.

5. The pedal unit according to claim 1, further comprising two sliding elements arranged between the inner housing and the movable housing, the return spring being arranged and supported between the two sliding elements.

6. The pedal unit according to claim 5, wherein each of the two sliding elements comprises an axial protrusion as an inner spring guide and a radial protrusion as a spring support.

7. The pedal unit according to claim 3, wherein the at least one sensor module of the at least one measuring circuit comprises at least two redundant sensor modules that employ different measurement principles or the same measurement principle to detect the movement of the coupling element.

8. The pedal unit according to claim 7, wherein at least one of the at least two redundant sensor modules is configured as a force measurement sensor, which detects the movement of the coupling element via the at least one spring element, which is coupled to the coupling element.

9. The pedal unit according to claim 7, wherein at least one of the at least two sensor modules is configured as a magnetic travel sensor that detects the movement of the coupling element without contact via a magnet arranged on the coupling element.

10. The pedal unit according to claim 1, wherein:
the at least one measuring circuit comprises two separate measuring circuits, each of which includes one or more sensor modules of the at least one sensor module and an external electrical interface, and each of the two separate measuring circuits is sealed in the sensor housing from the other of the two separate measuring circuits and is sealed outwardly against external media, and
a bottom covers and seals an opening in the sensor housing facing away from the pedal head.

11. The pedal unit according to claim 1, wherein the sensor housing is fluid-tightly connected to the fixable inner housing.

12. The pedal unit according to claim 1, wherein the fixable outer housing is connected and sealed to the movable housing at an opening facing the pedal head via an elastic first seal.

13. The pedal unit according to claim 1, wherein the fixable outer housing and the fixable inner housing are fluid-tightly connected to one another at ends facing away from the pedal head.

14. The pedal unit according to claim 13, wherein the fixable outer housing and the fixable inner housing each have circumferential ring flanges on respective end faces facing away from the pedal head, each circumferential ring flange having at least two fastening lugs which at least partially overlap.

15. The pedal unit according to claim 1, further comprising at least one anti-rotation device arranged between the fixable outer housing and the movable housing, the at least one anti-rotation device disabling rotation of the movable housing.

16. The pedal unit according to claim 15, wherein the at least one anti-rotation device includes a web on an inner side of the fixable outer housing and a recess with raised ends on an outer side of the movable housing, the raised ends being supported on opposite sides of the web.

17. The pedal unit according to claim 1, further comprising a circumferential annular protrusion pushed onto the fixable outer housing or formed on the fixable outer housing.

18. The pedal unit according to claim 17, further comprising an attachment having a hollow base body pushed onto the fixable outer housing, the attachment including the circumferential annular protrusion on an end side facing the pedal head.

19. The pedal unit according to claim 1, further comprising a circumferential elastic annular connection pushed onto the fixable outer housing, the circumferential elastic annular connection having a sealing lip on a radial edge abutting the fixable outer housing and a receiving edge on a radial edge facing away from the fixable outer housing.

20. The pedal unit according to claim 1, wherein the controllable vehicle function is a braking function or an acceleration function.
